(19) United States
(12) Patent Application Publication
(10) Pub. No.: US 2017/0253453 A1
(43) Pub. Date: Sep. 7, 2017

(54) SHEET TRANSFER ASSEMBLY

(71) Applicant: OCE-TECHNOLOGIES B.V., Venlo (NL)

(72) Inventors: Peter G. LA VOS, Venlo (NL); Daisuke KAWAGUCHI, Venlo (NL)

(73) Assignee: OCE-TECHNOLOGIES B.V., Venlo (NL)

(21) Appl. No.: 15/599,610

(22) Filed: May 19, 2017

Related U.S. Application Data
(63) Continuation of application No. PCT/EP2015/077554, filed on Nov. 24, 2015.

(30) Foreign Application Priority Data
Nov. 27, 2014 (EP) 14195107.9

(51) Int. Cl. B65H 29/24; B41J 11/00; B65H 7/06; B65H 29/36; B65H 5/02

(52) U.S. Cl. CPC B65H 29/24; B65H 29/36; B65H 5/02; B65H 7/06; B41J 11/00

(57) ABSTRACT

A sheet transfer assembly is provided for transferring a sheet from a supplying conveyor to a receiving conveyor. The receiving conveyor includes a transport belt having a support surface for supporting the sheet on a contact side of the sheet. The supplying conveyor is arranged for advancing the sheet in a transport direction towards the receiving conveyor. The sheet transfer assembly includes a sheet guidance element arranged downstream of the supplying conveyor in the transport direction for guiding the sheet towards the receiving conveyor, the sheet guidance element includes a guidance surface for supporting the sheet at its contact side; wherein the guidance surface includes two guide faces. Both guide faces extending in the transport direction over the support surface of the transport belt and being cooperatively arranged for supporting both side edge portions at the sides of the sheet in a lateral direction, which is substantially perpendicular to the transport direction, thereby forming a space in between one another allowing a middle portion of the sheet to move towards the support surface of the transport belt.

### FIELD OF THE INVENTION

The present invention relates to a sheet transfer assembly for transferring a sheet from a supplying conveyor to a receiving conveyor. The present invention further relates to a method for transferring a sheet from a supplying conveyor to a receiving conveyor. The present invention further relates to an inkjet printing apparatus comprising a supplying conveyor, a receiving conveyor and the sheet transfer assembly according to the present invention.

### BACKGROUND ART

A known inkjet printing apparatus comprises a supplying conveyor, a receiving conveyor and a sheet transfer assembly for transferring a sheet from the supplying conveyor to the receiving conveyor. The supplying conveyor, such as a print belt conveyor having a transport belt for advancing the sheet along an inkjet print station, is arranged for advancing the sheet in a transport direction towards the receiving conveyor. Said print station may be arranged for applying an inkjet image onto a process side of the sheet using an ink, such as by applying dots of an aqueous ink.

The supplying conveyor may have a suction mechanism arranged for providing a suction force to attract a contact side of the sheet towards the transport belt, the contact side being opposite to the process side. As such, a holding force is provided for driving the sheet in the transport direction towards the receiving conveyor along with the movement of the transport belt of the supplying conveyor.

The receiving conveyor comprises a transport belt having a support surface in contact with the contact side of the sheet for supporting the sheet. The receiving conveyor may further comprise a suction mechanism arranged for providing a suction force to attract the contact side of the sheet towards the support surface of the transport belt of the receiving conveyor.

The sheet transfer assembly comprises a sheet guidance element arranged downstream of the supplying conveyor in the transport direction for guiding the sheet towards the receiving conveyor. The sheet guidance element comprises a guidance surface for supporting the sheet in contact with the contact side of the sheet and guiding the sheet along the sheet guidance element towards the receiving conveyor.

The guidance surface of the sheet guidance element is arranged partly over the transport belt of the receiving conveyor. Behind the end of the guidance surface in the transport direction the sheet is allowed to land on the support surface of the transport belt of the receiving conveyor.

When the print station forms an inkjet image on the process side of the sheet by applying dots of an aqueous ink, the printed sheet becomes wet due to the aqueous ink dots. The moisture is absorbed into the sheet and enlarges the fibers of the sheet at the process side of the sheet depending on the sheet properties. As a result the sheet may become curled at the side edges and/or the corners of the sheet depending on the amount of ink applied on the sheet, wherein said curl is downward curl deformation towards the contact side of the sheet. Said curled sheet, when ejected from the sheet guidance element, may land first at these curled side edges and/or corners on the transport belt of the receiving conveyor. Furthermore, at the point the suction mechanism of the receiving conveyor attracts the contact side of the sheet, wrinkles may grow in the sheet as the sheet is not allowed to sufficiently flatten on the support surface of the transport belt of the receiving conveyor. These wrinkles may even become fixed in the sheet during a drying step of the printed sheet in a drying unit arranged downstream of the sheet transfer assembly.

The guidance surface according to the prior art comprises two tilted guide plates arranged at both sides of the guidance surface along the sheet transport direction, which are tilted with respect to the guidance surface to lift side edges of the sheet and to correct said downward curl deformation towards an upward curl deformation. However, especially in case the downward curl is not equal for both side edges and/or corners of the sheet, the correction of the curl may be insufficient and the tilted guide plates may disturb the alignment of the sheet relative to the transport direction due to unbalanced friction of the sheet along both tilted guide plates.

### SUMMARY OF THE INVENTION

It is accordingly an object of the present invention to provide a sheet transfer assembly for transferring a sheet from a supplying conveyor to a receiving conveyor while preventing or at least diminishing wrinkling of said sheet on the transport belt of the receiving conveyor without disturbing alignment of the sheet with respect to the transport direction.

The present invention provides a sheet transfer assembly for transferring a sheet from a supplying conveyor to a receiving conveyor, the sheet transfer assembly comprising the supplying conveyor and the receiving conveyor, the receiving conveyor comprising a transport belt having a support surface for supporting the sheet on a contact side of the sheet, the supplying conveyor being arranged for advancing the sheet in a transport direction towards the receiving conveyor;
the sheet transfer assembly comprising a sheet guidance element arranged downstream of the supplying conveyor in the transport direction for guiding the sheet towards the receiving conveyor, the sheet guidance element comprising a guidance surface for supporting the sheet in contact with at its contact side;
wherein the guidance surface comprises two guide faces, both guide faces extending in the transport direction over the support surface of the transport belt and being cooperatively arranged for supporting both side edge portions at the sides of the sheet in a lateral direction, which is substantially perpendicular to the transport direction, thereby forming a space in between one another allowing a middle portion of the sheet to move towards the support surface of the transport belt.

The guide faces of the guidance surface correct downward curl deformation of the sheet by supporting both side edge portions at each side of the sheet while the space in between the guide faces allows a middle portion of the sheet to move downwards towards the support surface of the transport belt of the receiving conveyor. The guide faces prevent the side edge portions to land on the support surface of the transport belt such that the middle portion of the sheet is landed first on the support surface of the transport belt prior to the side edge portions. As a result wrinkling of the sheet on the transport belt of the receiving conveyor is reduced. Furthermore the guide faces provide limited friction to the sheet thereby maintaining proper alignment of the sheet with respect to the transport direction.

The guidance surface, such as the guide faces, may further comprise a friction reducing portion for reducing friction with the sheet. Said friction reducing portion may be made up of a low-friction member composing the guidance surface. Further said friction reducing portion may comprise a plurality of protrusions formed on the guidance surface, such as concave and convex portions formed on the guidance surface, and may comprise ribs extending along the transport direction. The friction reducing portions provide a reduction of friction with the sheet to maintain proper alignment of the sheet with respect to the transport direction.

The two guide faces may be arranged substantially parallel to the guidance surface upstream of the guide faces in the transport direction. The substantially flat or level arrangement of the guide faces with respect to the rest of the guidance surface further reduces friction with the sheet in order to maintain alignment of the sheet with respect to the transport direction. In another embodiment the two guide faces may be tilted substantially towards the support surface of the transport belt away from the guidance surface upstream of the guide faces.

More specific optional features of the invention are indicated in the dependent claims.

In an embodiment, the sheet transfer assembly further comprising a landing air knife and a control unit configured for controlling the landing air knife, the landing air knife being coupled to an air supply source and arranged for applying an air flow onto a process side of the sheet, the process side being opposite to the contact side, thereby urging the sheet with its contact side onto the support surface of the transport belt. The air flow of the landing air knife pushes the middle portion of the sheet towards the support surface of the transport belt of the receiving conveyor. A timing and/or amplitude of the air flow are controlled by control unit for urging the sheet with its contact side onto the support surface of the transport belt.

In an embodiment, the landing air knife is arranged for directing the air flow substantially perpendicular to the support surface of the transport belt. The arrangement provides an effective use of the air flow for urging the middle portion of the sheet with its contact side onto the support surface of the transport belt.

In an embodiment, the landing air knife comprises manifold outlets arranged for directing the air flow onto the sheet in a landing area proximate to the two guide faces of the guidance surface. The arrangement enhances the effect of the two guide faces for maintaining the side edge portions of the sheet above the support surface of the transport belt, while urging the middle portion of the sheet onto the support surface of the transport belt. In a particular embodiment, the landing area is arranged for at least in part overlapping the two guide faces of the guidance surface. In this embodiment curled side edge portions of the sheet are urged against the two guide faces, thereby further correcting downward curl deformation of the side edge portions of the sheet.

In an embodiment, the landing area is arranged for at least in part overlapping the space between the two guide faces of the guidance surface. In this embodiment the air flow is directed to urge the middle portion of the sheet with its contact side onto the support surface of the transport belt in said space in between the two guide faces while at the same position in the transport direction maintaining the side edge portions of the sheet above the support surface of the transport belt by the two guide faces.

In an embodiment, the receiving conveyor comprises a suction unit arranged for attracting the contact side of the sheet in a suction area onto the support surface of the transport belt proximate to the two guide faces of the guidance surface. The suction unit provides a suction force in the suction area. The suction force enhances the middle portion of the sheet to first land on the support surface of the transport belt prior to the side edge portions of the sheet.

In a particular embodiment the suction unit is configured to provide a suction force to the middle portion of the sheet upstream in the transport direction of providing a suction force to the side edge portions of the sheet. For example the suction unit comprises chambers, wherein a first chamber for providing a suction force to the middle portion of the sheet is arranged upstream in the transport direction of a second chamber for providing a suction force to both the side edge portions of the sheet and the middle portion of the sheet. The suction unit further enhances flattening of the sheet from the middle portion of the sheet to the side edge portions of the sheet.

In an embodiment, the guidance surface comprises openings arranged for reducing air pressure build up between the contact side of the sheet and the guidance surface. The openings, such as hole or slots, prevent forming of a pressure chamber between the sheet and the guidance surface which may lead to lift of the middle portion of the sheet. The holes reduce or minimize downwards curl deformation of the sheet. The opening may be holes, may be slots or may have any suitable form for reducing air pressure build up between the contact side of the sheet and the guidance surface.

In an embodiment, the control unit is configured for controlling the landing air knife in response to at least one sheet attribute of the sheet, wherein the at least one sheet attribute comprises a media characteristic of the sheet. The control of the landing air knife may be used to optimize the air flow for urging the sheet with its contact side onto the support surface of the transport belt, for example depending on curl characteristics of the sheet based on media characteristics and/or ink amount applied on the process side of the sheet.

In another aspect of the present invention a method is provided for transferring a sheet from a supplying conveyor to a receiving conveyor, the receiving conveyor comprising a transport belt having a support surface for supporting the sheet on a contact side of the sheet, the method comprising the steps of: advancing the sheet by the supplying conveyor in a transport direction towards the receiving conveyor; guiding the sheet by a sheet guidance element to the receiving conveyor, thereby supporting the sheet on a guidance surface in contact with the contact side of the sheet; supporting the contact side of the sheet on two guide faces of the guidance surface, both guide faces extending in the transport direction over the support surface of the transport belt and being cooperatively arranged for supporting both side edge portions at the sides of the sheet in a lateral direction, which is substantially perpendicular to the transport direction, thereby forming a space in between one another allowing a middle portion of the sheet to move towards the support surface of the transport belt.

In an embodiment, the method further comprises the step of: applying an air flow onto a process side of the sheet proximate to the two guide faces, the process side being opposite to the contact side, to urge the sheet with its contact side of the sheet onto the support surface of the transport belt.

In an embodiment, the method further comprises the step of: attracting the contact side of the sheet by suction pressure onto the support surface of the transport belt in a suction area proximate to the two guide faces.

In an embodiment, wherein the air flow step comprises controlling the landing air flow in response to at least one sheet attribute of the sheet, wherein the at least one sheet attribute comprises a media characteristic of the sheet. The media characteristic of the sheet defines a curl deformation behavior of the sheet.

An inkjet printing apparatus comprising the sheet transfer assembly according to the present invention, the supplying conveyor comprising a transport belt having a support surface for supporting the sheet in contact with a contact side of the sheet, the supplying conveyor being arranged for advancing the sheet in a transport direction towards the receiving conveyor along a print station, which comprises a print head assembly configured for providing inkjet droplets on an process side of the sheet, the process side being opposite to the contact side.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

Hereinafter, the present invention is further elucidated with reference to the appended drawings showing non-limiting embodiments and wherein

FIG. 1 shows a cut sheet image forming system, wherein printing is achieved using a inkjet printing system.

FIG. 2A and 2B show an embodiment is shown of a sheet transfer assembly according to the present invention.

FIG. 2C shows a cross section of the guidance surface through the two guide faces of the sheet transfer assembly shown in FIGS. 2A-2B.

FIGS. 3A and 3B shows another embodiment is shown of a sheet transfer assembly according to the present invention.

FIG. 3C shows a cross section of the guidance surface through the two guide faces of the sheet transfer assembly shown in FIGS. 3A-3B.

FIG. 4 shows a modified embodiment of the sheet transfer assembly shown in FIGS. 3A-3C.

FIG. 5 shows the control scheme of the control unit controlling the landing air knife of the sheet transfer assembly and the suction units of the supplying conveyor and the receiving conveyor.

### DETAILED DESCRIPTION OF EMBODIMENTS

The present invention will now be described with reference to the accompanying drawings, wherein the same reference numerals have been used to identify the same or similar elements throughout the several views.

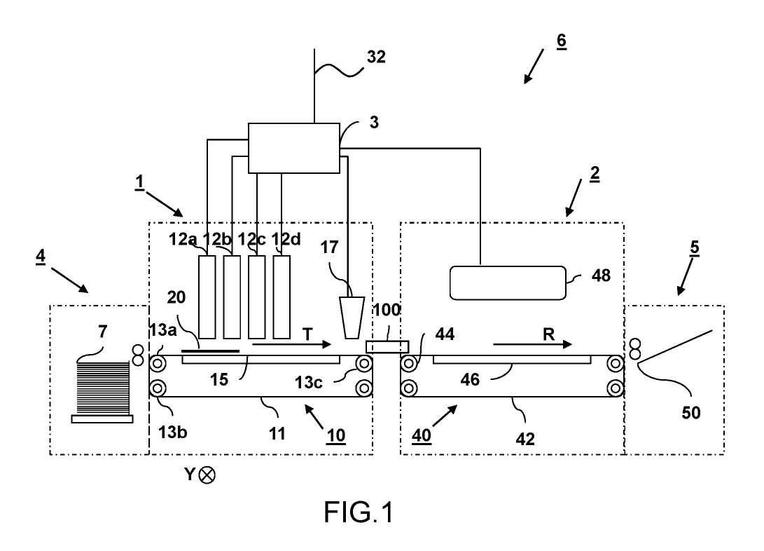

In FIG. 1 an inkjet printing system 6 is shown. The inkjet printing system 6 comprises an inkjet marking module 1, an inkjet print drying module 2 and a data controller 3. The controller is connected to a network through a network cable 32. The print data enters the controller through the network and is further processed. The print data can be saved on a non-volatile memory like a hard disk and sent to the inkjet marking module 1 using an interface board (not shown).

A cut sheet supply module 4 supplies a receiving medium 20 to the inkjet marking module 1. In the cut sheet supply module 4 the receiving medium is separated from a pile 7 and brought in contact with the transport belt 11 of the supplying conveyor 10 of the inkjet marking module 1. The supplying conveyor further comprises an assembly of belt rollers 13a-13c.

The inkjet marking module 1 comprises an assembly of four color inkjet print heads 12a-12d. The transport belt 11 transports the receiving medium to the area beneath the four color inkjet print heads 12a-12d. The colors provided by the inkjet print heads 12a-12d is black, cyan, magenta and yellow. When receiving the print data, the inkjet print heads 12a-12d each generate droplets of inkjet marking material and position these droplets on the receiving medium 20.

The transport belt 11 is transported by the assembly of belt rollers 13a-13c. The transport belt 11 is transported by one roller belt roller 13a in the transport direction of T, and the position of the transport belt 11 in the direction Y is steered by means of another belt roller 13b. The transport belt 11 comprises holes and the receiving medium 20 is held in close contact with said belt 11 by means of an air suction device 15. After the inkjet marking material has been printed on the receiving medium, the receiving medium 20 is moved to an area beneath a scanner module 17. The scanner module 17 determines the position of each of the four color images on the receiving medium 20 and sends this data to the data controller 3.

The receiving medium is transported to by the supplying conveyor 10 towards a receiving conveyor 40 of the inkjet print drying module 2. The receiving conveyor 40 of inkjet print drying module 2 comprises a transport belt 42, which is transported by an assembly of belt rollers 44 for further advancing the sheet 20 in the transport direction R. The receiving medium 20 is attracted to the transport belt 42 by means of an air suction device 46 and is dried on the belt by means of a heating device 48, thereby evaporating the liquid of the inkjet marking material. The dried print product is made available on a tray 50 in the print storage module 5. In between the supplying conveyor 10 and the receiving conveyor 40 a sheet transfer assembly 100 is arranged for transferring a sheet from the supplying conveyor 10 to the receiving conveyor 40. Said sheet transfer assembly 100 may for example be the sheet transfer assembly according to the present invention.

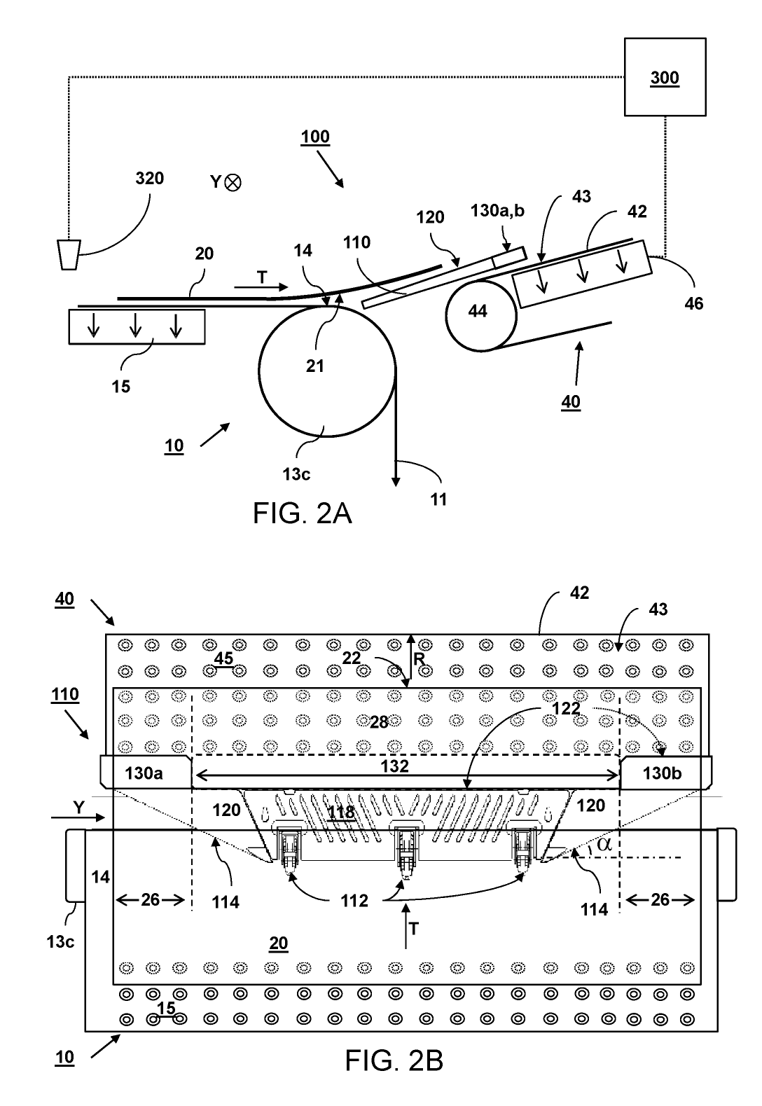

Now referring to FIG. 2A and 2B an embodiment is shown of a sheet transfer assembly according to the present invention. FIG. 2A shows an enlarged side view of both the supply conveyor 10, showing the transport belt 11 and one of the deflection rollers 13c of the supply conveyor 10, and the receiving conveyor 40, showing the transport belt 42 and one of the belt rollers 44. A sheet 20 is placed with a contact side 21 on a support surface 14 of the transport belt 11 and advanced by the transport belt 11 in a transport direction T by moving the transport belt in the transport direction T towards the deflection roller 13c. The sheet is attracted to the support surface of the transport belt 14 by a suction unit 15 which is arranged adjacent to the transport belt 11 for providing a suction force through the holes of the transport belt 11 to the contact side of the sheet 21.

The sheet transfer assembly 100 comprises a sheet guidance element 110 arranged downstream of the supplying conveyor 10 in the transport direction T for guiding the sheet 20 towards the receiving conveyor 40. The sheet guidance element 110 comprises a guidance surface 120 for supporting the sheet 20 in contact with the contact side 21 of the sheet 20 and guiding the sheet 20 along the sheet guidance element 110 towards the receiving conveyor 40.

Now referring to FIG. 2B showing a plane view on the guidance surface 120 of the sheet guidance element 110.The guidance surface 120 of the sheet guidance element 110 is arranged partly over the transport belt 42 of the receiving conveyor 40. Behind the rear end of the guidance surface 122 in the transport direction the sheet 20 is allowed to land on the support surface of the transport belt 42 of the receiving conveyor 40. The transport belt 42 advances the sheet 20 further in the direction R. In this view the sheet 20 is held partly by the supplying conveyor 10, in part is supported by the guidance surface 120 and in part has landed on the support surface of the transport belt 42 of the receiving conveyor 40. The leading edge of the sheet 22 is moved past the guidance surface 120 of the sheet guidance element 110. The guidance surface 120 comprises two guide faces 130a, 130b extending in the transport direction T over the support surface 43 of the transport belt 42 and being cooperatively arranged for supporting both side edge portions 26 at each side of the sheet 20 relative to a lateral direction Y, which is substantially perpendicular to the transport direction T, thereby forming a space 132 in between the two guide faces 130a, 130b allowing a middle portion 28 of the sheet to move towards the support surface 43 of the transport belt 42. The sheet guidance element 110 at the rear end of the guidance surface 122, and in particular at the rear end of the two guide faces 130a, 130b in the transport direction T, has a smooth rear edge 122, which is shaped substantially round for smoothly guiding the contact side of the sheet 21 to move downwards towards the transport belt 42 without damaging the contact side of the sheet 21, including any ink being present on said contact side of the sheet 21. Said rear edge 122 preferably has a curved shape having a mean diameter of at least 0.05 mm.

The receiving conveyor 40 comprises a suction unit 46 which is arranged for providing a suction force through holes of the transport belt 42 to the contact side of the sheet 21. The contact side of the sheet 21 is attracted onto the support surface 43 of the transport belt 42 in a suction area 45.

As shown in FIG. 2B the sheet guidance element 110 further comprises separation needles 112, guidance edges 114 and the guidance surface 120 comprises openings 118. The separation needles 112 are arranged protruding from the guidance surface 120 of the sheet guidance element 110 close to the support surface of the transport belt 14 of the supplying conveyor 10 and are configured for lifting the leading edge of the sheet 22 away from the transport belt 11 during a separation sheet of the sheet 20 from the transport belt 14 of the supplying conveyor 10 (not shown). The separation needles 112 may be arranged contacting the support surface of the sheet transport belt 14 or may be arranged at a close distance, such as about 0-0.3 mm. The separation needles 112 are distributed over a middle section of the transport belt 11 in a lateral direction Y, which is perpendicular to the transport direction T. The separation needles 112 comprise support surfaces (not shown) arranged for guiding the contact side of the sheet 21 towards the guidance surface 120 of the sheet guidance element 110.

The guidance edges 114 are arranged at each side of the distributed separation needles 112 in the lateral direction Y. Each guidance edge 114 is arranged at an acute angle α with respect to the lateral direction Y, wherein said angle a is about 10-30 degrees. The guidance edges 114 are arranged for guiding the leading edge 22 and side edges of the sheet 20 onto the guidance surface 120 of the sheet guidance element 110 during a separation step of the sheet 20 from the transport belt 14 of the supplying conveyor 10 (not shown).

Especially in case corners of the sheet 20 at the leading edge 22 are curled downwards towards the transport belt 11, the guidance edges 114 guide the corners of the sheet 20 onto the guidance surface of the sheet guidance element 110.

The guidance surface 120 is arranged substantially parallel to the transport direction T. Alternatively the guidance surface 120 may be arranged at a small angle with respect to the transport direction T for further lifting the sheet 20 from the transport belt 11 upwards in the direction of the process side of the sheet 20.

The guidance surface 120 comprises a plurality of openings 118, which have the shape of slots or holes and which extend in a direction having an acute angle with the transport direction T. The plurality of openings 118 are arranged for removing any air pressure build up between a sheet 20 and the guidance surface 120. The acute angle is selected for guiding the edges of the sheet 20 over the guidance surface 120.

Now referring to FIG. 2C, which shows a cross section of the guidance surface 120 through the guide faces 130a, 130b and the support surface 43 of the transport belt 42 of the receiving conveyor 40. In FIG. 2C the effect of the guide faces 130a, 130b is shown on the landing of the sheet 20 on the transport belt 42 of the receiving conveyor 40.

The guide faces 130a, 130b are arranged above the transport belt 42 of the receiving conveyor 40. The guide faces 130a, 130b of the guidance surface 120 correct any downward curl deformation of the sheet by supporting both side edge portions 26 at each side of the sheet 20 while the space 132 in between the guide faces allows a middle portion 28 of the sheet to move downwards S towards the support surface of the transport belt 42 of the receiving conveyor 40. The guide faces 130a, 130b prevent the side edge portions 26 to land on the support surface of the transport belt 42 such that the middle portion of the sheet 28 is landed first on the support surface of the transport belt 42 prior to the side edge portions 26. As a result wrinkling of the sheet 20 on the transport belt 42 of the receiving conveyor 40 is reduced. Furthermore the guide faces 130a, 130b provide limited friction to the sheet 20 in the transport direction T thereby maintaining proper alignment of the sheet 20 with respect to the transport direction T.

The receiving conveyor 40 comprises a suction unit 46 which is arranged adjacent to the transport belt 42 for providing a suction force through holes of the transport belt 42 to the contact side of the sheet 21. The contact side of the sheet 21 is attracted onto the support surface 43 of the transport belt 42 in the suction area 45 (as shown in FIG. 2B). The suction area 45 is arranged such that it enhances the middle portion 28 of the sheet to first land on the support surface 43 of the transport belt prior to the side edge portions 26 of the sheet. The suction unit 46 is controlled by control unit 300, which may control the suction unit 46 based on a sheet detection signal provided by the detector unit 320. In a particular embodiment (not shown) the suction unit 46 comprises chambers, wherein a first chamber for providing a suction force to the middle portion of the sheet 28 is arranged upstream in the transport direction T of a second chamber for providing a suction force to both the side edge portions of the sheet 26 and the middle portion of the sheet 28. The suction unit in this embodiment further enhances flattening of the sheet 20 from the middle portion of the sheet 28 to the side edge portions of the sheet 26.

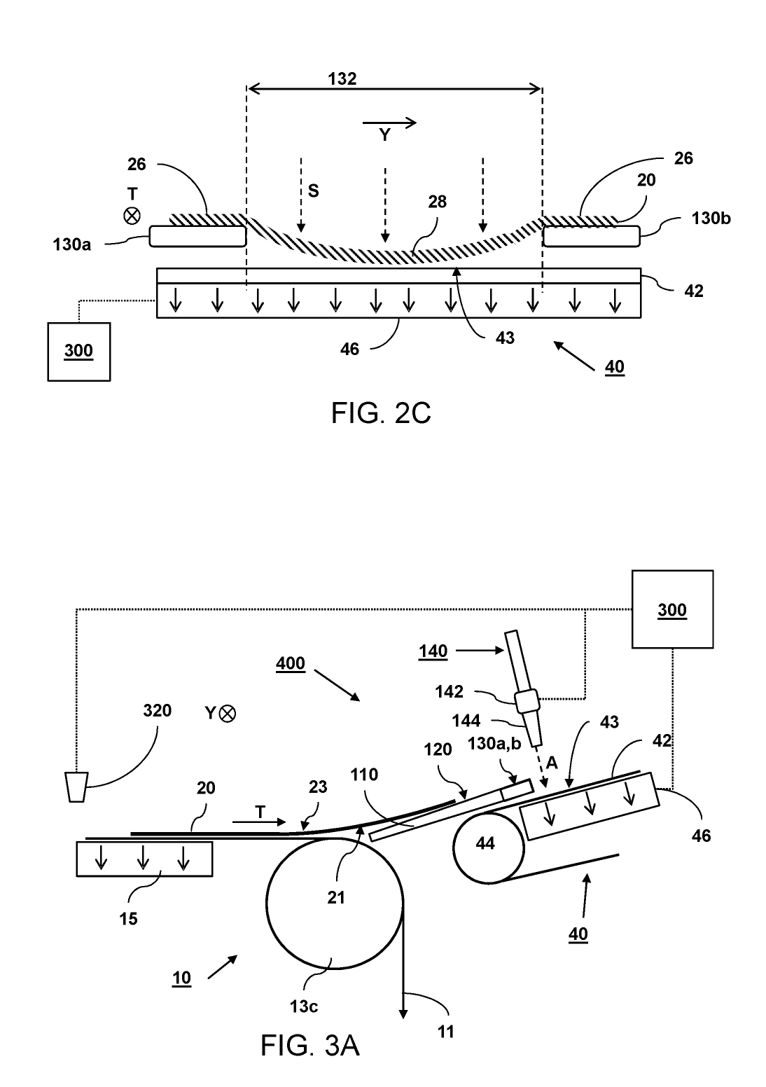

Now referring to FIGS. 3A and 3B another embodiment is shown of a sheet transfer assembly according to the present invention. FIG. 3A shows an enlarged side view of both the supply conveyor 10, showing the transport belt 11 and one of the deflection rollers 13c of the supply conveyor 10, and the receiving conveyor 40, showing the transport belt 42 and one of the belt rollers 44.

The sheet transfer assembly 400 comprises the sheet guidance element 110 shown in the embodiment shown in FIG. 2A-2C and additionally comprises a landing air knife 140 being coupled to an air supply source (not shown).

The air knife 140 is arranged for applying an air flow A onto a process side 23 of the sheet, the process side 23 being opposite to the contact side 21, thereby urging the sheet 20 with its contact side 21 onto the support surface 43 of the transport belt 42. The landing air knife 140 comprises a manifold outlet 144 arranged substantially perpendicular to the process side 23 of the sheet proximate to the two guide faces 130a, 130b.

Now referring to FIG. 3B showing a plane view on the guidance surface 120 of the sheet guidance element 110 and the support surface of the transport belt 42. The guidance surface 120 of the sheet guidance element 110 is arranged partly over the transport belt 42 of the receiving conveyor 40. Behind the rear end of the guidance surface 122 in the transport direction the sheet 20 is allowed to land on the support surface of the transport belt 42 of the receiving conveyor 40. The transport belt 42 advances the sheet 20 further in the direction R.

In this view the sheet 20 is held partly by the supplying conveyor 10, in part is supported by the guidance surface 120 and in part has landed on the support surface of the transport belt 42 of the receiving conveyor 40. The leading edge of the sheet 22 is moved past the guidance surface 120 of the sheet guidance element 110.

The air flow A is directed in a landing area A proximate to the two guide faces 130a, 130b onto the process side of the sheet 20. The landing area A extends in the lateral direction Y over the middle portion of the sheet 28. The landing area A also extends in the lateral direction Y along the space 132 between the two guide faces 130a, 130b. The receiving conveyor 40 comprises a suction unit 46 which is arranged for providing a suction force through the transport belt 42 to the contact side of the sheet 21. The contact side of the sheet 21 is attracted onto the support surface 43 of the transport belt 42 in a suction area 45. The suction area 45 is arranged such that it at least partly overlaps the landing area A provided by the landing air knife 140.

Now referring to FIG. 3C, which shows a cross section of the guidance surface 120 through the guide faces 130a, 130b, the landing air knife 140 and the support surface 43 of the transport belt 42 of the receiving conveyor 40.

The air flow A of the landing air knife 140 urges the middle portion of the sheet 28 towards the support surface 43 of the transport belt 42 of the receiving conveyor 40 as indicated by arrow U.

The control unit 300 is configured for controlling an air pressure valve 142 of the landing air knife. As such a timing and/or amplitude of the air flow A are controlled by control unit 300 for urging the sheet 20 with its contact side onto the support surface 43 of the transport belt 42. Air pressure is provided towards the landing air knife 140 by two air supply tubes 146 arranged at both ends of the landing air knife 140 in the lateral direction Y. In this embodiment the manifold outlet 144 and/or the air supply tubes 146 are arranged for providing a maximum air flow amplitude (such as air flow velocity or air flow force) onto the middle portion 28 of the sheet, while the air flow amplitude directed onto the side edge portions of the sheet 26 is less than said maximum air flow amplitude. This focusing arrangement of the air flow amplitude provides a further enhancement of moving the middle portion of the sheet 28 towards the support surface 43 of the transport belt 42 prior to the side edge portions of the sheet 26. The suction force provided by the suction unit 46 through holes of the transport belt 42 further enhances the middle portion 28 of the sheet to first land on the support surface 43 of the transport belt prior to the side edge portions 26 of the sheet.

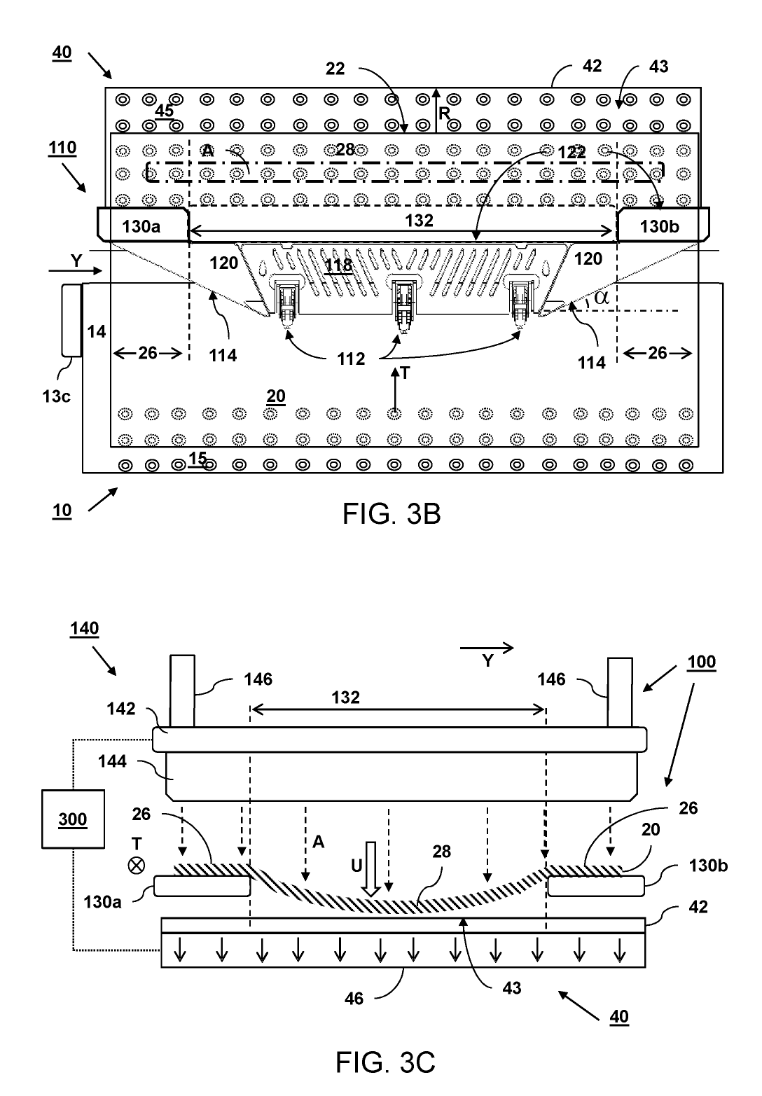

Now referring to FIG. 4 wherein a modified embodiment is shown of the sheet transfer assembly shown in FIGS. 3A-3C. FIG. 4 shows schematically the sheet transfer assembly in a plane view of the sheet guidance element 110, showing the guidance surface 120 including the two guide faces 130a, 130b and the space 132 in between the two guide faces 130a, 130b. The landing knife 140 (not shown) provides an air flow A in a landing area A′, wherein said landing area A′ is arranged within the space 132 in between the two guide faces 130a, 130b. Said air flow A′ provides an even stronger force for urging a middle portion of the sheet, which is arranged over the space 132, towards a support surface 43 of the transport belt 42.

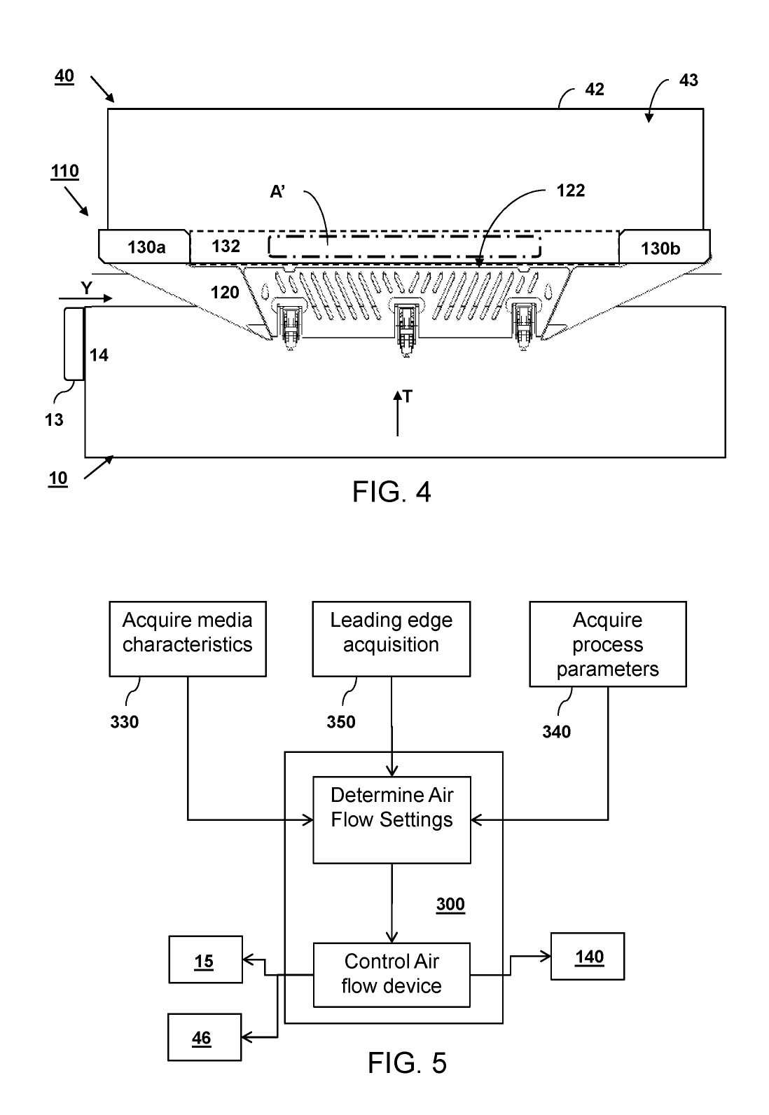

Now referring to FIG. 5 the control unit 300 controls the air flow provided by the landing air knife 140 and the suction pressure provided by the suction units 15 and 46 of the supplying conveyor 10 and the receiving conveyor 40 respectively.

In regards to the landing air knife 140 attributes of the air flow A is controlled in respect of air flow settings as air flow pressure [bar], air flow volume [l/min], air flow speed [m/s] and air flow timing [millisecond]. The air flow pressure is controlled in the range of 0-5 bar. The air flow volume is controlled in the range of 0-200 l/min. The air flow volume depends on the air flow restrictions of the landing air knife and on the air flow pressure. The air flow speed is controlled in the range of 0-50 m/s and also depends on the air flow restriction of the landing air knife and on the air flow pressure.

The air flow timing of the landing air knife 140 is important for the functioning of the sheet transfer assembly 100. The control unit 300 determines the air flow timing [millisecond] of the landing air knife 140 based on media characteristics 330 of the sheet 20 and/or based on process parameters 340 of the sheet 20, such as advancing speed of the transport belt 11 in the transport direction T and such as ink coverage of the sheet 20 based on print data and droplet sizes used. Furthermore the control unit 300 determines a starting timing [millisecond] of the air flow timing in response to receiving a leading edge acquisition 350 from the sensor 320 (as is shown in FIGS. 2A and 3A) of the leading edge 22 of the sheet. The timing of the air flow A is optimized to urge the sheet 20 close to the leading edge 22 to the support surface 43 of the transport belt 42. For example the air flow A is started at the moment the leading edge 22 arrives at the two guide faces 130a, 130b. Optionally the air flow A may be stopped in case a sufficient part of the sheet 20 has properly landed on the support surface 43 of the transport belt 42 without growing wrinkles in the sheet 20.

Examples of media characteristics 330 are heavy coated paper, plain paper, coated offset paperoffset paper, grammage of the media (e.g. in g/m2), or any other media characteristics 330 which are related to curl deformation behavior of the sheet 20, such as due to internal tension in the sheet in response to the application of an ink coverage on the sheet 20. The control unit 300 comprises or is connected to a database comprising media characteristics 330 which are related to optimal air flow settings.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A sheet transfer assembly for transferring a sheet from a supplying conveyor to a receiving conveyor, the sheet transfer assembly comprising the supplying conveyor and the receiving conveyor, the receiving conveyor comprising a transport belt having a support surface for supporting the sheet on a contact side of the sheet, the supplying conveyor being arranged for advancing the sheet in a transport direction towards the receiving conveyor;
the sheet transfer assembly comprising a sheet guidance element arranged downstream of the supplying conveyor in the transport direction for guiding the sheet towards the receiving conveyor, the sheet guidance element comprising a guidance surface for supporting the sheet at its contact side;
wherein the guidance surface comprises two guide faces, both guide faces extending in the transport direction over the support surface of the transport belt and being cooperatively arranged for supporting both side edge portions at the sides of the sheet in a lateral direction, which is substantially perpendicular to the transport direction, thereby forming a space in between one another allowing a middle portion of the sheet to move towards the support surface of the transport belt.

2. The sheet transfer assembly according to claim 1, the sheet transfer assembly further comprising a landing air knife and a control unit configured for controlling the landing air knife, the landing air knife being coupled to an air supply source and arranged for applying an air flow onto a process side of the sheet, the process side being opposite to the contact side, thereby urging the sheet with its contact side onto the support surface of the transport belt.

3. The sheet transfer assembly according to claim 2, wherein the landing air knife is arranged for directing the air flow substantially perpendicular to the support surface of the transport belt.

4. The sheet transfer assembly according to claim 2, wherein the landing air knife comprises manifold outlets arranged for directing the air flow onto the sheet in a landing area proximate to the two guide faces of the guidance surface.

5. The sheet transfer assembly according to claim 4, wherein the landing area is arranged for at least in part overlapping the space between the two guide faces of the guidance surface.

6. The sheet transfer assembly according to claim 1, wherein the receiving conveyor comprises a suction unit arranged for attracting the contact side of the sheet in a suction area onto the support surface of the transport belt proximate to the two guide faces of the guidance surface.

7. The sheet transfer assembly according to claim 1, wherein the guidance surface comprises openings arranged for reducing air pressure build up between the contact side of the sheet and the guidance surface.

8. The sheet transfer assembly according to claim 2, wherein the control unit is configured for controlling the landing air knife in response to at least one sheet attribute of the sheet, wherein the at least one sheet attribute comprises a media characteristic of the sheet.

9. A method for transferring a sheet from a supplying conveyor to a receiving conveyor, the receiving conveyor comprising a transport belt having a support surface for supporting the sheet on a contact side of the sheet, the method comprising the steps of:
a. advancing the sheet by the supplying conveyor in a transport direction towards the receiving conveyor;
b. guiding the sheet by a sheet guidance element to the receiving conveyor, thereby supporting the sheet on a guidance surface in contact with the contact side of the sheet;
c. supporting the contact side of the sheet on two guide faces of the guidance surface, both guide faces extending in the transport direction over the support surface of the transport belt and being cooperatively arranged for supporting both side edge portions at each side of the sheet relative to a lateral direction, which is substantially perpendicular to the transport direction, thereby forming a space in between one another allowing a middle portion of the sheet to move towards the support surface of the transport belt.

10. The method according to claim 9, wherein the method further comprising the step of:
d. applying an air flow onto a process side of the sheet proximate to the two guide faces, the process side being opposite to the contact side, to urge the sheet with its contact side of the sheet onto the support surface of the transport belt.

11. The method according to claim 9, wherein the method further comprising the step of:
e. attracting the contact side of the sheet by suction pressure onto the support surface of the transport belt in a suction area proximate to the two guide faces.

12. The method according to claim 10, wherein step d. comprises controlling the landing air flow in response to at least one sheet attribute of the sheet, wherein the at least one sheet attribute comprises a media characteristic of the sheet.

13. An inkjet printing apparatus comprising the sheet transfer assembly according to the claim 1, the supplying conveyor comprising a transport belt having a support surface for supporting the sheet in contact with a contact side of the sheet, the supplying conveyor being arranged for advancing the sheet in a transport direction towards the receiving conveyor along a print station, which comprises a print head assembly configured for providing inkjet droplets on an process side of the sheet, the process side being opposite to the contact side.
